(19) United States
(12) Patent Application Publication
(10) Pub. No.: US 2005/0118980 A1
(43) Pub. Date: Jun. 2, 2005

(54) Variable rate RC calibration circuit with filter cut-off frequency programmability

(76) Inventors: Hung-Chuan Pai, San Diego, CA (US); Liang Dai, Carlsbad, CA (US); Kevin Hsi-Hwai Wang, San Diego, CA (US); Jie Huang, San Diego, CA (US)

Correspondence Address: Hung Chang Lin, 8 Schindler Ct., Silver Spring, MD, 20903, US

(21) Appl. No.: 10/724,415

(22) Filed: Dec. 1, 2003

(51) Int. Cl. H04B 1/16

(52) U.S. Cl. 455/340

(57) ABSTRACT

Two reference signals are applied to an RC calibration circuit, which utilizes programmable resistors and switched capacitor resistors in parallel at the inputs of a differential amplifier with feedback capacitors, for the first cycle and then the two reference signals are swapped for the successive cycle. The circuit inherent DC offset is cancelled by these two successive cycles. The time duration when the difference of the differential amplifier outputs in the calibration circuit starts to reverse ramping direction and the time when the difference crosses zero is counted in terms of reference clock cycles by a binary counter. The binary count is used to select the capacitance of the capacitor arrays in an RC filter for time constant calibration. This calibration circuit provides the flexibility for various reference clock rates by adjusting the programmable resistors. By tuning the same programmable resistors, this calibration circuit in addition provides the capability to changing the cut-off frequency of an RC filter circuit to another predetermined value.

### BACKGROUND OF THE INVENTION

1. Field of Invention

The present invention relates to resistor and capacitor monolithic process calibration and, more particularly, to an RC calibration circuit with filter cut-off frequency programmability for filters that include resistors and capacitors in their structures.

2. Description of Related Art

The on chip resistors (R) and capacitors (C) can vary over a huge range even in most updated monolithic process. The variation of the RC directly causes the deviation of the filter cut-off frequency. One way of compensating the filter cut-off frequency deviation is through the use of a set of tunable capacitor array controlled by an RC calibration circuit. The RC calibration circuit simply adjusts the capacitance in the filter capacitor array to bring the cut-off frequency back to the desired value.

FIG. 1 shows a exemplary application for the RC calibration circuit to compensate the cut-off frequency deviation of a first order active-RC filter, which can also be considered as a building block of a higher order active-RC filter. The filter transfer function in FIG. 1 is

$$\frac{Vo ( s )}{Vi ( s )} = \frac{- 1 / ( Ri * Carray )}{s + 1 / ( Rf * Carray )} \qquad EQ . 1$$

From EQ. 1, by tuning Carray, the capacitance of an array of addressable parallel binary-weighted capacitors as in a charge-redistribution D/A converter, the filter cut-off frequency can be adjusted. FIG. 2 shows a conventional RC calibration circuit; FIG. 3 is the control-timing diagram including waveforms of some internal nodes in FIG. 2. The whole calibration circuit is based on a precise reference clock with period of Tclk. The feedback capacitor C₀ is first discharged for P*Tclk duration, where P is an pre-defined integer and is going to be introduced later, then charged for 2^{N}*Tclk duration through R₁, and finally discharged for (P+2^{N})*Tclk duration through the resistor equivalence of a switched capacitor C₁. The purpose is to find the time period, η, for Vo reversing ramp direction till crossing V_{AG}. The N-bit counter, pre-loaded with P, is enabled for this η duration and counts up from −P; the final N-bit count at the end of this η duration is then applied to control the capacitance of filter capacitor array by means of digital-to-analog conversion.

Nevertheless, one severe issue in FIG. 2 is that if there exists a DC offset on the opamp, the Vo acts like the ones shown in FIG. 4. The opamp DC offset causes Vo to change ramping slopes. It therefore changes the counter enabled duration (to be η′ or η″ instead of η) and results in wrong calibration codes. In addition, the input DC offset voltage on the followed comparator also causes the deviation of η and results in another failure reason for this calibration circuit. Unfortunately, the DC offset on the opamp and comparator is inherent and unpredictable in the monolithic process. There are some ways to store the DC offset on capacitors at one phase and then cancel it at the other phase but those approaches promptly complicate the calibration circuit by adding lots of switches and timing controls.

The RC calibration circuit in FIG. 2 is based on a fixed reference clock rate. If the reference clock rate is changed, the calibrated result is no longer proper from the original design. To extend the flexibility of the calibration circuit, a robust design for variable reference clock rates is desired.

In some applications, filter cut-off frequency programmability is required. From the example in FIG. 1 and EQ. 1, one way of tuning filter cut-off frequency and maintaining the same DC gain after RC calibration (Carray decided) is to tune Ri and Rf. Nevertheless, both Ri and Rf are on the signal path, extra switches on the signal path will cause the performance distortion. Especially, for low noise applications, the resistor resistance is small for reducing thermal noise and the extra switch resistance may be non-negligible compared with the resistance of Ri and Rf, which means the RC calibration result is off from the right filter cut-off frequency control. Moreover, for a high order filter, the switch number increases quickly and it complicates the filter circuit by involving much more controls.

Thus, there is a need for a RC calibration circuit that is immune from DC offset, allows variable reference clock rates, and provides filter cut-off frequency programmability.

### SUMMARY OF THE INVENTION

An object of the present invention is to provide a self-tuned RC calibration circuit to be immune from DC offset voltages. Another object of the present invention is to provide a method for the self-tuned RC calibration circuit allowing for changeable reference clock rates. A further object of the present invention is to have the filter cut-off frequency programmability being included into the self-tuned RC calibration circuit.

The self-tuned RC calibration circuit of the present invent comprises switches for multiplexing two input reference signals through programmable resistors in parallel with switched capacitor resistors to a differential amplifier with feedback capacitors. Using the two input reference signals, the feedback capacitors are first charged through the programmable resistors and then discharged through the switched capacitor resistors in the first calibration cycle. The second calibration cycles are sequentially executed with swapped input reference signals to the differential amplifier. Briefly, the impact of the DC offset in the calibration circuit is cancelled by applying swapped input reference signals for two successive calibration cycles. The total duration when the difference of the differential amplifier outputs starts to reverse ramping direction and the time when the difference crosses zero in the two calibration cycles is counted in terms of reference clock cycles by a binary counter. The final count is directly utilized to set the capacitor array capacitance in an (active- and passive-) RC filter for RC time constant calibration.

In according with the present invent, if different reference clock rate is applied, the calibration result is still valid once the programmable resistors in the calibration circuit is tuned according to the ratio of the new reference clock period to the original based period.

Moreover, by tuning the resistance of the programmable resistors with the ratio of the changed cut-off frequency to the default cut-off frequency, the calibration circuit further provides the capability of changing the cut-off frequency of an (active- and passive-) RC filter circuit to another predetermined value.

The calibration circuit is additionally capable of dealing with the case of different calibration reference clock rate plus changed filter cut-off frequency, by tuning the resistance of the programmable resistors according to the reference clock period changing ratio times the filter cut-off frequency changing ratio.

### BRIEF DESCRIPTION OF THE DRAWINGS

FIG. 1 is an exemplary application for utilizing the RC calibration result to compensate a (first order active-RC) filter cut-off frequency deviation;

FIG. 2 shows a conventional RC calibration circuit;

FIG. 3 is a timing diagram for FIG. 2;

FIG. 4 illustrates the impact of opamp DC offset in FIG. 2;

FIG. 5 is a schematic diagram in accordance with the present invention for the self-tuned calibration circuitry;

FIG. 6 is a timing diagram illustrating the operation in FIG. 5;

FIG. 7 is a diagram to describe the capacitor array design (in an active- and passive-RC filter) and its exemplary covered tuning range to include process and temperature variation plus filter cut-off frequency programmable range.

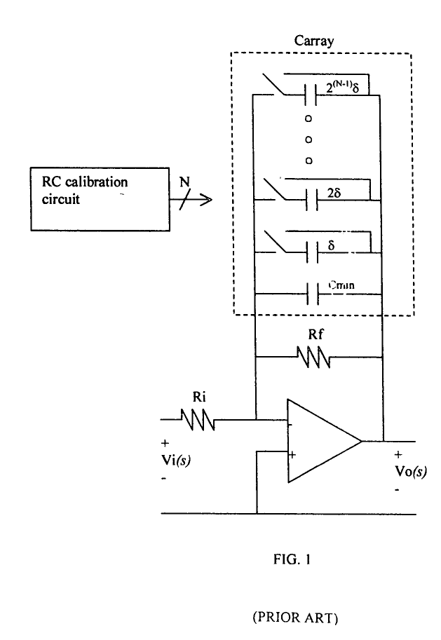

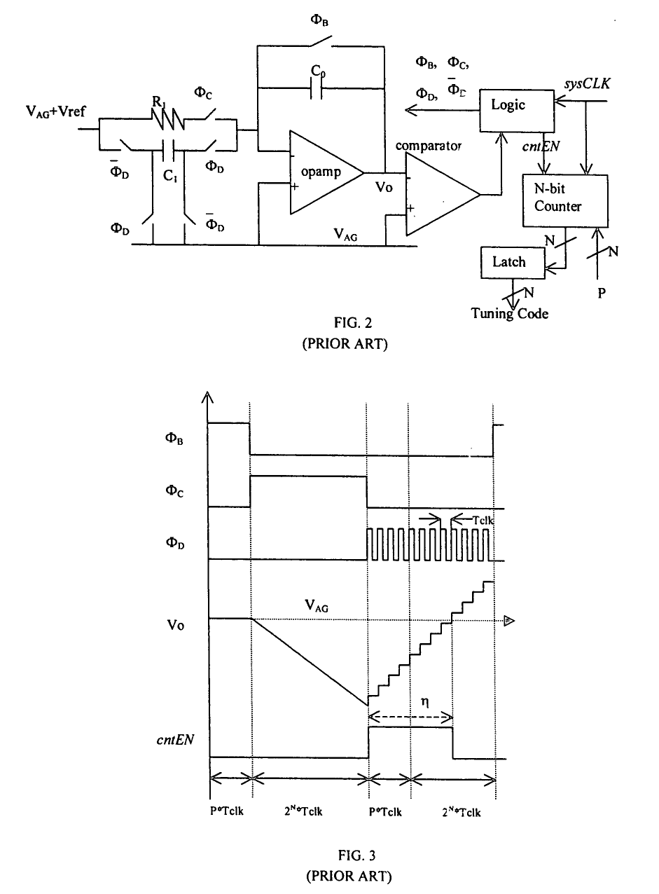

### DETAIL DESCRIPTION OF THE EMBODIMENT

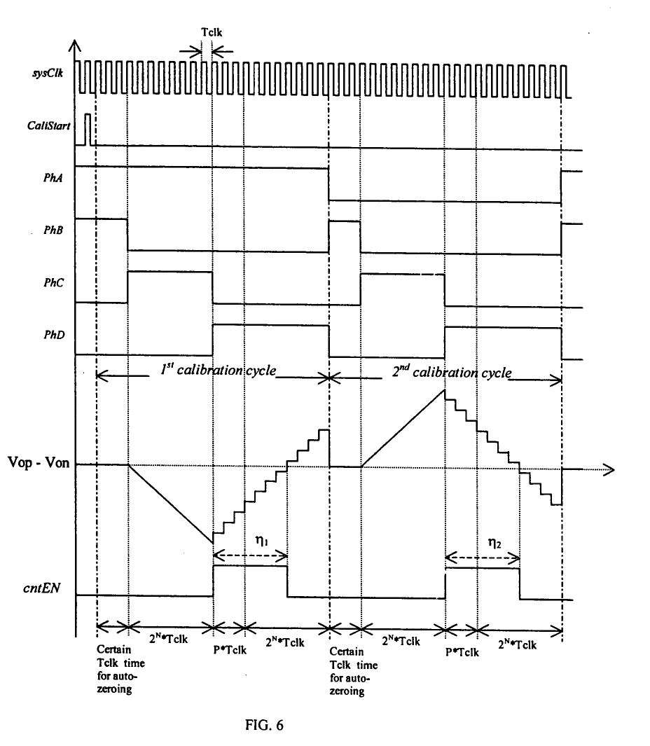

FIG. 5 is the schematic diagram that shows a self-tuned RC calibration circuitry in accordance with the present invention. FIG. 6 is the timing diagram demonstrating the operation in FIG. 5. Note that both feedback capacitors C₀ₐ and C_{0b} have the same capacitance of C₀, both switched capacitor resistors C₁ₐ and C_{1b} have the same capacitance of C₁, and both programmable resistors R₁ₐ and R_{1b} have the same resistance of R₁. During the 1^{st} calibration cycle, the difference of the differential amplifier outputs, (Vop−Von), changes slopes as a first dual-slope ramp signal with gradients of [∂(Vop−Von)/∂t]⁻=−(Vref1+Vref2)/(R₁*C₀*τ) and [∂(Vop−Von)/∂t]⁺=(Vref1+Vref2)*C₁/(C₀*Tclk), where τ is the ratio of nominal to ideal on-chip RC time constant and Tclk is the period of a precise reference clock. Timing arrangement is created such that the circuit is auto-zeroed (shortening individual two ends of C₀ₐ and C_{0b}) for certain amount of Tclk cycles to settle all circuitry. Thereafter, (Vop−Von) ramps for 2^{N}*Tclk at speed of [δ(Vop−Von)/δt]⁻ and then reverses ramping direction at speed of [δ(Vop−Von)/δt]⁺, passing through zero at some time η₁ later. η₁ can be obtained by the following equation:
(Vref1+Vref2)/(R₁*C₀*τ)*2^{N}*Tclk=(Vref1+Vref2)*C₁/(C₀*Tclk)*η₁ [symbol]
η₁=2^{N}*T²clk/(R₁*C₁*τ). EQ. 2
Similarly, by swapping the two input reference signals, Vcm+Vref1 and Vcm−Vref2, through \overline{Ph4} for the 2^{nd} calibration cycle, (Vop−Von) is generated as a second dual-slope ramp signal in opposite direction as the previous dual-slope ramp signal and
η₂=2^{N}*T²clk/(R₁*C₁*τ). EQ. 3
Note that, ideally, η₁ and η₂ have the same expression and the reason of using two calibration cycles will be clear later. For simplicity, the 1^{st} calibration cycle is used to illustrate the algorithm. The Ti duration on the cntEN signal enables the (N+1)-bit counter in the control logic block to count the cycles of the reference clock. The (N+1)-bit counter, pre-loaded with an integer P, counts up from −P and gets a count n at the end of η₁ duration. Therefore,
η₁=(n+P+0.5±φ)*Tclk, EQ. 4
where, −0.5≦φ≦0.5 is the quantization error due to the stepped procession of (Vop−Von) in this period. The count n can be obtained by equating EQ. 2 and EQ. 4,
n=2^{N}*Tclk/(R₁*C₁*τ)−(P+0.5)±φ. EQ. 5

On the other hand, the filter capacitor array tuning range needs to be defined to cover not only the process and temperature variation but also the filter cut-off frequency programmable range. For simplicity and clarity, through the description of the algorithm, numbers will be sequentially assigned to parameters but not limited to those given numbers. For instance, +−5% is assumed for the targeted calibration accuracy. (Certainly, any different numbers assigned in the algorithm will result in different consequences.)

The first step of the algorithm is to find out the RC variation range due to process and temperature changes. To cover (say) three standard deviations, the RC process plus temperature variation locates between (say) 0.61 and 1.5 (RC time constant varies from 39% less to 50% more compared with the nominal one). In addition, for default filter cut-off frequency of (say) 7 MHz, to include the filter cut-off frequency programmable range of (say) 7 MHz˜10 MHz into the covered calibration range, the total variation should extend to 0.61*7M/7M=0.61˜1.5*10M/7M=2.143. Therefore, the filter capacitor should cover the tuning range of 1/2.143=0.46˜1/0.61=1.64. For convenience, the covered tuning range of, say, 0.45 (−55%) ˜1.65 (+65%) is assumed for the following calculation.

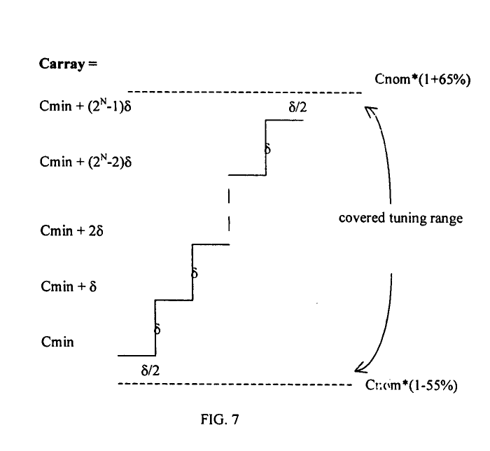

The filter capacitor is implemented by an array of addressable parallel binary weighted capacitors to cover the mentioned tuning range:
Carray=Cmin+n*δ, EQ. 6
where, Cmin is a fixed capacitance, δ is the unit capacitance, n is an integer in the range of [0˜2^{N}−1] with N for N-bit capacitor array, and Carray is the total array capacitance associated with n. Using Carray to represent a nominal capacitance of Cnom and a tuning range of (say) −55% ˜+65% around Cnom, the relationship of Cnom, Carray, and quantization level is illustrated in FIG. 7.
From FIG. 7,

$$\begin{matrix}\begin{matrix}δ = [ Cnom ( 1 + 65 \% ) - Cnom ( 1 - 55 \% ) ] / {2}^{N} \\ = 1.2 * Cnom / {2}^{N} ,\end{matrix} & EQ . 7 \\ \begin{matrix}Cmin = Cnom ( 1 - 55 \% ) + δ / 2 \\ = δ * {2}^{N} / 1.2 * 0.45 + δ / 2 \\ = δ * {2}^{N} * 0.375 + δ / 2.\end{matrix} & EQ . 8\end{matrix}$$

The array has a maximum quantization error approximately
εₘₐₓ˜+−δ/2/[Cnom*(1−55%)]
˜+−δ/2/[2^{N}/1.2*δ*0.45]
˜+−1/2^{N}*4/3. EQ. 9
If maximum quantization error of (say) +−5% is tolerable, from EQ. 9, N=5 is chosen and εₘₐₓ˜+−4.17%. Therefore, δ=0.0375*Cnom and Cmin=12.5*δ.

The ratio of nominal to ideal on-chip RC time constant is defined as τ; thereafter, the required nominal time constant is equated to the tuned fabricated time constant as
R*Cnom=R(Cmin+n*δ)τ, EQ. 10
where, from EQ. 7, Cnom=2^{N}*δ/1.2. The relationship between code n and RC time constant variation ratio τ is then

$$\begin{matrix}n = 1 / τ * ( Cnom / δ ) - Cmin / δ & EQ . 11 \\ = 1 / τ * ( {2}^{N} / 1.2 ) - 12.5 . & EQ . 12\end{matrix}$$

If the count n in EQ. 5 (from calibration circuit) equals the code n in EQ. 12 (from filter capacitor array), then the number from calibration circuit self-tunes the filter capacitor array. By comparing EQ. 5 with EQ. 12 and assuming φ=0, the following conditions satisfy the previous statement:
R₁*C₁=1.2*Tclk, EQ. 13
P=12. EQ. 14
Note that, Tclk, one reference clock period, comes from an accurate source, for example, a crystal clock. For selected Vref1 and Vref2, the choices of C, and C₀ depend on the (Vop−Von) ramping step, which should be much larger than the integrated noise from the differential amplifier output. Once C₁ is decided, R₁ is available from EQ. 13. In addition, R₁*C₀*τ decides the peak magnitude of (Vop−Von).

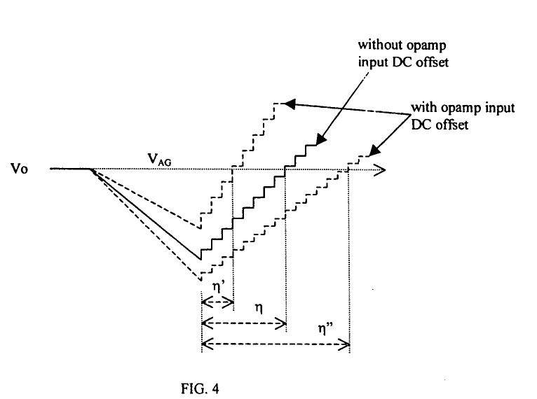

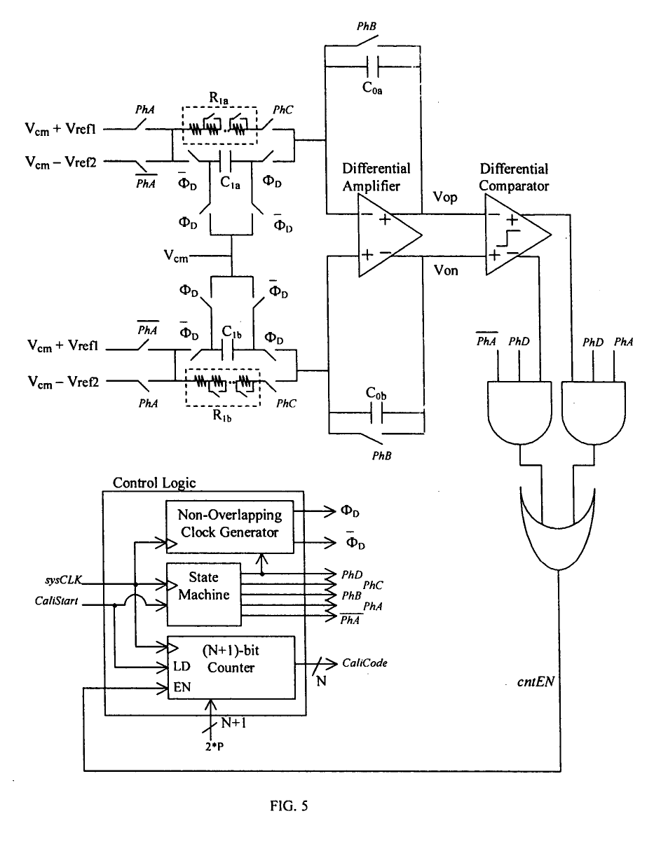

In real circuit implementation, if DC offset voltage appears at the inputs of differential amplifier, the slope of (Vop−Von) changes and results in the η₁ duration to be incorrect (as shown in FIG. 4.) This issue can be simply corrected by running two successive calibration cycles with the input reference signals, Vcm+Vref1 and Vcm−Vref2, being swapped through phA and \overline{PhA} for individual calibration cycle as demonstrated in FIG. 5 and FIG. 6. Because the cntEN possesses the same total high duration of (η₁+η₂) with or without DC offset on the differential amplifier input, the differential amplifier DC offset impact is solved. In addition, running two successive calibration cycles also cancels the DC offset from the differential comparator. Thereafter, to meet the previously mentioned criteria, (N+1)-bit counter is applied and the initial number loaded to the counter should be 2*P because two calibration cycles are executed. Meanwhile, the final calibrated code to control the N-bit filter capacitor array should be the most significant N bits from the (N+1)-bit counter (because of dividing by 2).

To maximize the applications of a chip, the RC calibration circuitry should also tolerate various reference clock rates. From EQ. 13, the reference clock rate can be different because R₁ₐ and R_{1b} in FIG. 5 are made programmable with resistance adjusted according to the possible reference clock period changes; the calibrated result is still valid.

To even extend the flexibility of this self-tuned calibration circuit, the filter cut-off frequency changing ratio can also be obtained from the resistance changing ratio of the programmable resistors R₁ₐ and R_{1b} in FIG. 5. For instance, if resistance R₁ is changed to, say, 1.4*R₁, then from EQ. 5 and EQ. 11, Cnom is equivalently reduced to Cnom/1.4 (through calibrated code n) and consequently filter cut-off frequency is increased by 1.4 times. Hence, the filter cut-off frequency is programmable through the calibration circuit. Note that the switches added for tuning R₁ₐ and R_{1b} (while their resistance R₁ is usually very large for power saving and better matching) in the calibration circuit have negligible impact to the filter circuit. The advantages of programming filter cut-off frequency through calibration circuit include no extra switches, no extra distortion, and no extra controls on the filter circuit.

In general, by referring to FIG. 5 and FIG. 6, the complete procedure follows. Pre-set the resistance of the programmable resistors R₁ₐ and R_{1b} according to the current clock period and required filter cut-off frequency as mentioned above. Once the calibration circuit receives a calibration start signal, CaliStart, with system clock, sysCLK, the control logic block loads a pre-defined number 2*P, where P is an integer obtained from the previously described self-tuned calibration algorithm, and generates timing signals PhA, PhB, PhC, PhD, \overline{PhA}, Φ_{D}, and \overline{Φ}_{D}. PhA is on for a first fixed time duration (1^{st} calibration cycle) comprising sub-duration 1, sub-duration 2, and sub-duration 3. PhA selects the first reference signal of Vcm+Vref1 for the inverting input path of the differential amplifier and the second reference signal of Vcm−Vref2 for the non-inverting input path of the differential amplifier. PhB is on for sub-duration 1 to short-circuit the individual two ends of C₀ₐ and C_{0b} (auto-zeroing) and to settle whole circuitry. Thereafter, PhC is on for sub-duration 2 (say, 2^{N}*Tclk) to charge C₀ₐ through R₁ₐ and charge C_{0b} through R_{1b}. Then PhD is on and non-overlapping signals Φ_{D} and \overline{Φ}_{D} operate for sub-duration 3 (say, P*Tclk+2^{N}*Tclk) to discharge C₀ₐ through C₁ₐ and discharge C_{0b} through C_{1b}. The differential comparator takes the differential outputs of the differential amplifier and the non-inverting output result is passed to cntEN, a counter enable signal, in this sub-duration. cntEN is high to enable the (N+1)-bit counter in the control logic block, counting up from −2*P, between Vop−Von reversing ramp direction and crossing zero.

Followed by the first fixed time duration, \overline{PhA} is on for a second fixed time duration (2^{nd} calibration cycle) comprising sub-duration 4, sub-duration 5, and sub-duration 6. \overline{PhA} selects the second input reference signal of Vcm−Vref2 for the inverting input path of the differential amplifier and the first input reference signal of Vcm+Vref1 for the non-inverting input path of the differential amplifier. Similarly, PhB is on for sub-duration 4 to short-circuit the individual two ends of C₀ₐ and C_{0b} (auto-zeroing) and to settle whole circuitry. Thereafter, PhC is on for sub-duration 5 (say, 2^{N}*Tclk) to charge C₀ₐ through R₁ₐ and charge C_{0b} through R_{1b}. Then PhD is on and non-overlapping signals Φ_{D} and \overline{Φ}_{D} operate for sub-duration 6 (say, P*Tclk+2^{N}*Tclk) to discharge C₀ₐ through C₁ₐ and discharge C_{0b} through C_{1b}. The inverting output result of the differential comparator is passed to cntEN in this calibration cycle. cntEN is high to enable the (N+1)-bit counter again, counting up following the count from previous calibration cycle, between Vop−Von reversing ramp direction and crossing zero. At the end of the 2^{nd} calibration cycle, the most significant N bits of the (N+1)-bit counter are directly applied to set the capacitance of filter capacitor arrays.

In one embodiment, the programmable resistors, R₁ₐ and R_{1b}, provides the flexibility for variable reference clock rates if EQ. 13 and EQ. 14 are still satisfied (assuming for the previously assigned parameters.) In addition, the programmable resistors, R₁ₐ and R_{1b}, also provides the filter cut-off frequency programmability by tuning the R₁ₐ and R_{1b} resistance with the same ratio as cut-off frequency changed. The merit of this approach is that, through the calibrated number, the Carray capacitance is changed to the reciprocal ratio and causes the filter cut-off frequency to change this ratio.

In yet another embodiment, by swapping the two input reference signals, Vcm+Vref1 and Vcm−Vref2, on the 1^{st} and the 2^{nd} calibration cycles, the impact of the DC offsets from the differential amplifier and the differential comparator are all cancelled, making this calibration circuitry immune from DC offset. Note that the symmetry of the two reference signals to Vcm is not compulsory, which means Vref1 can be different from Vref2. The swap of the reference signals on the two calibration cycles also cancels the affection of shifted reference signals. In summary, running two calibration cycles with swapped reference signals gains not only DC offset immunity but also the relaxation of reference signal generation.

The scope of the invention should not be restricted to the described particular embodiments for illustration Instead, it should cover all modifications and equivalents within the appended claims.

1. A method of calibrating RC time constant of an RC filter using a differential amplifier with a coupling capacitor C between each output terminal and each input terminal of the differential amplifier and a resistor R between each input terminal and each input reference signal, comprising the steps of:
using a first calibration cycle; and
using a second calibration cycle to cancel the offset error of the differential amplifier.

2. The method of calibrating RC time constant as described in claim 1,
wherein the first calibration cycle uses as a first input reference signal, which is the sum of a common mode voltage Vcm and a first reference voltage Vref1, and a second input reference signal, which is the difference of Vcm minus a second reference voltage Vref2, to said differential amplifier to generate a first dual-slope ramp signal;
wherein the second calibration cycle repeats the first calibration cycle but using a reverse input reference signals to the differential amplifier to generate a second dual-slope ramp signal, and
wherein the time slots for the first and second dual-slope ramp signals to reverse ramping direction and cross zero are used to calibrate the value of the capacitance of the RC time constant.

3. The method of calibrating RC time constant of an RC filter as described in claim 2, wherein said first calibration cycle and said second calibration cycle comprise the steps of:
pre-loading a predefined number to a (N+1)-bit counter;
generating a control signal PhA for a first fixed time duration which comprises sub-duration 1, sub-duration 2, and sub-duration 3,
wherein sub-duration 1 is an auto-zeroing duration, during which a control signal PhB is generated to short-circuit a feedback capacitor C₀ₐ between an inverting input and non-inverting output of said differential amplifier through a first series input programmable resistor R₁ₐ connected between said inverting input and said first input reference signal, and to short-circuit a feedback capacitor C_{0b} between a non-inverting input and inverting output of said differential amplifier through a second series input programmable resistor R_{1b} connected between said non-inverting input and said second input reference signal,
wherein a control signal PhC is generated for said subduration 2 such that the first input reference signal charges said C₀ₐ through said R₁ₐ, and the second input reference signal charges said C_{0b} through said R_{1b},
wherein control signals PhD, Φ_{D} and \overline{Φ}_{D} are generated for said sub-duration 3 such that said C₀ₐ is discharged through a first switched capacitor equivalent resistor with capacitor C₁ₐ switched by clocks Φ_{D} and \overline{Φ}_{D} and said C_{0b} is discharged through a second switched capacitor equivalent resistor with capacitor C_{1b} switched by clocks Φ_{D} and \overline{Φ}_{D};
generating a control signal \overline{PhA} for a second fixed time duration which comprises sub-duration 4, sub-duration 5, and sub-duration 6,
wherein sub-duration 4 is an auto-zeroing duration [of the differential amplifier], during which said control signal PhB is generated to short-circuit the individual two ends of said C₀ₐ and C_{0b},
wherein said control signal PhC is generated for said sub-duration 5 such that the second input reference signal charges said C₀ₐ through said R₁ₐ and the first input reference signal charges said C_{0b} through said R_{1b},
wherein said control signals PhD, Φ_{D} and \overline{Φ}_{D} are generated for said sub-duration 6 such that said C₀ₐ is discharged through said first switched capacitor equivalent resistor with capacitor C₁ₐ switched by clocks Φ_{D} and \overline{Φ}_{D} and said C_{0b} is discharged through said second switched capacitor equivalent resistor with capacitor C_{1b} switched by clocks Φ_{D} and \overline{Φ}_{D};
generating a first duration η₁ when the difference of the non-inverting output and the inverting output of said differential amplifier reverses ramping direction and crosses zero in said sub-duration 3;
generating a second duration η₂ when the difference of the non-inverting output and the inverting output of said differential amplifier reverses ramping direction and crosses zero in said sub-duration 6;
enabling said (N+1)-bit counter during the periods of η₁ and η₂; and
outputting from said (N+1)-bit counter the most significant N-bit count as a signal to set the capacitor array capacitance of an RC filter.

4. The method of calibrating RC time constant of an RC filter as described in claim 1, wherein the said RC filter is selected from the group consisting of: a low-pass, band-pass, high-pass, single and multiple order filter with resistors and capacitor arrays constituting RC time constant to be calibrated.

5. The method of calibrating RC time constant of an RC filter as described in claim 3, wherein said capacitor array is binary-weighted.

6. The method of calibrating RC time constant of an RC filter as described in claim 3, wherein said capacitor array is fed from a digital counter.

7. The method of calibrating RC time constant of an RC filter as described in claim 3, wherein a different calibration reference clock rate is used, further comprising the step of: pre-setting the resistance of said programmable resistors R₁ₐ and R_{1b} in claim 3 according to the ratio of the new reference clock period to the original based reference clock period.

8. The method of calibrating RC time constant of an RC filter as described in claim 3, wherein the filter default cut-off frequency is changed, further comprising the step of: pre-setting the resistance of said programmable resistors R₁ₐ and R_{1b} in claim 3 according to the ratio of the new filter cut-off frequency to the default filter cut-off frequency.

9. The method of calibrating RC time constant of an RC filter as described in claim 3, wherein a different calibration reference clock rate is used and the filter default cut-off frequency is changed, further comprising the step of:
pre-setting the resistance of said programmable resistors R₁ₐ and R_{1b} in claim 3 according to the ratio of the new reference clock period to the original based reference clock period times the ratio of the new filter cut-off frequency to the default filter cut-off frequency.

10. The method of calibrating RC time constant of an RC filter as described in claim 3, further comprising the step of running the steps of claim 3 multiple times.

11. The method of calibrating RC time constant as described in claim 3, wherein said RC filter is a passive filter.

12. The method of calibrating RC time constant as described in claim 3, wherein said RC filter is an active filter.

13. A variable rate RC calibration circuit comprising:
a differential amplifier with a first capacitor C₀ₐ between the inverting input and the non-inverting output of said differential amplifier and a second capacitor C_{0b} between the non-inverting input and the inverting output of said differential amplifier;
first input programmable resistor R₁ₐ to said inverting input and second programmable resistor R_{1b} to said non-inverting input of said differential amplifier,
first switched capacitor equivalent resistor with capacitor a C₁ₐ to said inverting input, and second switched capacitor equivalent resistor with a capacitor C_{1b} to said non-inverting input of said differential amplifier, and
calibration signals of calibrating R₁ₐC₁ₐ time constant and R_{1b}C_{1b} time constant in a first calibration cycle and a second calibration cycle to cancel the offset error of said differential amplifier.

14. The variable rate RC calibration circuit as described in claim 13, wherein the calibration signal of said first calibration cycle is a first dual-slope ramp signal and the calibration signal of said second calibration cycle is a second dual-slope ramp signal opposite to the first dual-slope ramp signal, and the time slots when the first and the second dual-slope ramp signals reverse ramping direction and cross zero are used to input a counter.

15. The variable rate RC calibration circuit as described in claim 14, wherein said time slot is quantized into steps and the number of steps are used to input the counter.

16. The variable rate RC calibration circuit as described in claim 15, wherein said time slot is quantized by discharging C₀ₐ and C_{0b} through switched capacitor resistors during second halves of said first ramp signal and second ramp signal.
